(19) United States
(12) Patent Application Publication
(10) Pub. No.: US 2026/0332612 A1
(43) Pub. Date: Oct. 22, 2026

(54) INFORMATION PROCESSING METHOD, INFORMATION PROCESSING APPARATUS, AND NON-TRANSITORY COMPUTER-READABLE RECORDING MEDIUM

(71) Applicant: Panasonic Intellectual Property Management Co., Ltd., Osaka (JP)

(72) Inventors: TATSUMI OBA, Chiba (JP); SEIYA KAMBAYASHI, Hyogo (JP); RIKIYA HIRAISHI, Aichi (JP)

(21) Appl. No.: 19/529,182

(22) Filed: Feb. 4, 2026

Related U.S. Application Data
(63) Continuation of application No. PCT/JP2024/016510, filed on Apr. 26, 2024.

(30) Foreign Application Priority Data
Aug. 29, 2023 (JP) 2023-139105

(51) Int. Cl. H04L 9/40; G06T 7/70; G06V 30/19

(52) U.S. Cl. CPC H04L 63/1416; G06T 7/70; G06V 30/19

(57) ABSTRACT

An information processing method includes detecting an anomaly in a packet and, in a case where the anomaly in the packet is detected, outputting, on the basis of the packet, an operation screen estimated to generate the packet.

### BACKGROUND

### 1. Technical Field

The present disclosure relates to an information processing method, an information processing apparatus, and a non-transitory computer-readable recording medium for detecting an anomaly in a packet.

### 2. Description of the Related Art

Conventionally, control devices installed in plant facilities or other facilities have involved the use of unique communication modes and operated in connection and communication with other devices through unique communication lines. However, in recent years, standards of communication between control devices involving the use of Ethernet (registered trademark) or IP (Internet protocol), which is a general-purpose protocol that has become higher in speed and lower in price with the wide use of the Internet, have been formulated.

Note here that in recent years, the use of general-purpose communication standards exposes control devices to higher risks of cyberattacks such as malware attacks. To address this problem, many attempts have been made within control system networks to monitor the networks by using an intrusion detection system (IDS) to detect anomalous communication. Since, in a control system, a process automatically occurs basically according to a predetermined logic and traffic (data) needed for the process is generated automatically, it is easy to learn behavior that serves as a basis. Therefore, there have been many cases of detection of anomalous communication with an IDS having a function of detecting an anomaly in the behavior.

Another example of a technique for detecting an anomaly in link with a user's operation information is disclosed in International Publication No. 2022/249816. International Publication No. 2022/249816 discloses an apparatus that, in a case where there occurs no user operation when an anomalous packet is observed, determines that there is a high possibility of a cyberattack.

### SUMMARY

Detection of an anomaly at a communication level is an effective way of performing cybersecurity monitoring. However, a large burden is entailed by analytical work of identifying a possible effect on the control system by a detected event and the cause of occurrence of the detected event in communications.

One non-limiting and exemplary embodiment provides an information processing method, an information processing apparatus, and a non-transitory computer-readable recording medium that make it easy to find the cause of generation of an anomalous packet.

In one general aspect, the techniques disclosed here feature an information processing method including detecting an anomaly in a packet and, in a case where the anomaly in the packet is detected, outputting, on the basis of the packet, an operation screen estimated to generate the packet.

The information processing method, the information processing apparatus, and the non-transitory computer-readable recording medium make it easy to find the cause of generation of an anomalous packet.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a block diagram showing a configuration of a control system in which a screen operation output apparatus according to an embodiment is used;

FIG. 2 is a block diagram showing a configuration of the screen operation output apparatus according to the embodiment;

FIG. 3 is a diagram showing pair information of IP addresses to be subjected to screen operation estimation by the screen operation output apparatus according to the embodiment;

FIG. 4 is a diagram showing configuration information of anomaly detection algorithms that are utilized by an anomaly detector according to the embodiment;

FIG. 5 is a diagram showing a maximum value/minimum value whitelist serving as one of the anomaly detection algorithms that are utilized by the anomaly detector according to the embodiment;

FIG. 6 is a diagram showing an image extracted by an image operation extractor according to the embodiment;

FIG. 7 is a diagram showing metadata extracted by a metadata extractor according to the embodiment;

FIG. 8 is a diagram showing type definition rules for control packets according to the embodiment;

FIG. 9 is a diagram showing a control type ID table stored in a main DB in correspondence with a screen operation according to the embodiment;

FIG. 10 is a diagram showing a packet metadata table stored in the main DB in correspondence with a screen operation according to the embodiment;

FIG. 11 is a diagram showing a screen operation information table stored in the main DB in correspondence with a screen operation according to the embodiment;

FIG. 12 is a diagram showing the contents of link configuration parameters according to the embodiment;

FIG. 13 is a diagram showing an example of an operation screen that is outputted by a visualizer when the anomaly detector according to the embodiment has detected an anomalous packet;

FIG. 14 is a diagram showing a method by which an updater estimates a position that is highlighted by the visualizer according to the embodiment as a place where an anomalous screen operation is being done and the position of a text box;

FIG. 15 is a diagram showing the contents of display position-identifying configuration parameters according to the embodiment;

FIG. 16 is a flow chart showing an overview of a process of the screen operation output apparatus according to the embodiment;

FIG. 17 is a flow chart of a process of linking a control packet and a screen operation according to the embodiment;

FIG. 18 is a flow chart of a display position update process according to the embodiment;

FIG. 19 is a flow chart of a screen operation output process according to the embodiment; and

FIG. 20 is a flow chart showing an information processing method that is executed by an information processing apparatus according to the embodiment.

### DETAILED DESCRIPTIONS

The following describes an embodiment of the present disclosure with reference to the drawings. The embodiment described here illustrates one specific example of the present disclosure. Accordingly, the numerical values, shapes, constituent elements, placement and topology of constituent elements, shapes, constituent elements, the placement and topology of constituent elements, steps, orders of steps, or other features that are shown in the following embodiment are merely examples and are not intended to limit the present disclosure. Further, those of the constituent elements in the following embodiment which are not recited in an independent claim are optionally addable constituent elements. Further, the drawings are schematic views and are not necessarily strict illustrations.

### Embodiment

The following describes a screen operation output apparatus according to an embodiment. This screen operation output apparatus establishes a link between an anomaly in communication and a screen operation.

### Configuration

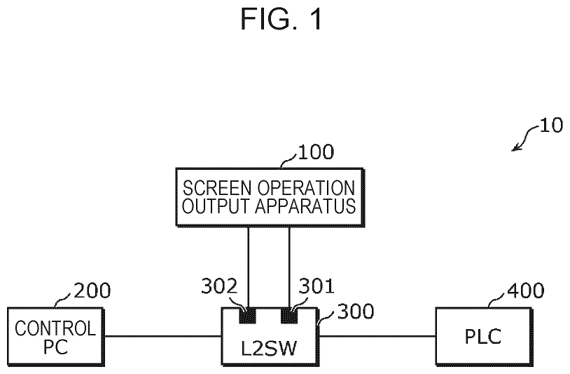

FIG. 1 is an example of a block diagram showing a configuration of a control system 10 in which the screen operation output apparatus 100 according to the embodiment is used. Specifically, FIG. 1 shows an overall configuration of the control system 10 in the present embodiment. In the present embodiment, the control system 10 includes apparatuses that perform communication under an appropriate protocol according to the characteristics of applications such as TCP/IP and UDP/IP on the Ethernet defined by IEEE 802.3.

First, constituent elements of the control system 10 are described.

As shown in FIG. 1, the control system 10 includes the screen operation output apparatus 100, a control PC (personal computer) 200, an L2SW (layer-2 switch) 300, and a PLC (programmable logic controller) 400. The constituent elements of the control system 10 may be placed, for example, inside a plant, or at least one or more of the constituent elements may be placed outside the plant.

In a control network (e.g. an in-plant network) that is used for communication by the apparatuses of the control system 10, the apparatuses are connected to one another via the L2SW 300. The control PC 200 and the PLC 400 are able to communicate with each other via the L2SW 300. The control PC 200 is an apparatus for controlling each production facility in the plant.

Although the control PC 200 is, for example, a desktop personal computer, the control PC 200 may be implemented, for example, as a tablet terminal. The control PC 200 is an example of an operating apparatus. The control PC 200 includes, for example, a display device that displays an operation screen for sending (generating) a packet (control packet), an input device that receives an operation (input) from a user, and a control device that performs a process of, for example, controlling a screen (image) that is displayed on the display device or sending a control packet to the PLC 400 in accordance with the operation received by the input device from the user.

The display device is, for example, a display that displays an operation screen, such as a GUI (graphical user interface), through which the user performs an operation.

The input device is a device for receiving an operation from the user and is, for example, a mouse and/or a keyboard. The input device may be implemented, for example, as a touch panel.

The control device is a computer that performs various types of information processing. The control device includes, for example, a communication interface, such as a communication circuit, for communicating with an information processing apparatus and a controlled apparatus via a network, a nonvolatile memory in which a program is stored, a volatile memory serving as a temporary storage area in which to execute the program, an input/output port through which to send and receive signals, a processor that executes the program, or other components.

By operating the control PC 200, the user sends, to the PLC 400, a control packet for controlling the PLC 400 (more specifically, a control packet with which the PLC 400 controls a production facility). Specifically, the user sends a control packet to the PLC 400 by operating a GUI displayed on the control PC 200. In so doing, the user sends a control packet to the PLC 400, for example, by performing, with the input device, an operation of, while looking at a GUI (specifically, an operation screen) displayed on the display device, for example, clicking the mouse so as to select an icon such as a send button on the GUI.

The term “screen operation” hereinafter means, for example, the user performing, with the input device, an operation of, while looking at an operation screen displayed on the display device, for example, clicking the mouse so as to select an icon such as a send button on the operation screen. For example, the screen operation is a general term for, for example, input received through an operation screen on the control PC 200, a click position on the operation screen, and keyboard input information.

The PLC 400 is an apparatus for automatically controlling each production facility in the plant and controls each production facility in accordance with a predetermined order or procedure. Although not illustrated, the PLC 400 is communicably connected to each production facility. The PLC 400 is able, for example, to control a plurality of motors, a plurality of actuators, or other components. For each of the plurality of motors and the plurality of actuators, an object ID for identification is set.

The PLC 400 is implemented, for example, as a communication interface, such as a communication circuit, for performing communication, a nonvolatile memory in which a program is stored, a volatile memory serving as a temporary storage area in which to execute the program, an input/output port through which to send and receive signals, a processor that executes the program, or other components. The PLC 400 is an example of a controlled apparatus.

The L2SW 300 is a repeater in the control network that performs a process of sending acquired information to an apparatus corresponding to the information. The L2SW 300 includes a mirror port 301 and a normal port 302.

The mirror port 301 is a port that can capture a packet flowing on a network switch. The mirror port 301 is also referred to as “monitor port”. The L2SW 300 has ports through which to connect many LAN (local area network) cables, and the mirror port 301 copies (mirrors) a packet flowing through a designated port. In the present embodiment, the screen operation output apparatus 100 is connected to the mirror port 301 and the normal port 302.

The screen operation output apparatus 100 is an apparatus that detects an anomaly in a packet flowing through the control network. Specifically, the screen operation output apparatus 100 detects an anomaly in a control packet that is sent to the PLC 400 via the control network.

A control packet contains, for example, a controlling value for controlling the PLC 400. Upon receiving (acquiring) a control packet, the PLC 400 controls a motor, an actuator, or other components in accordance with a controlling value contained in the control packet.

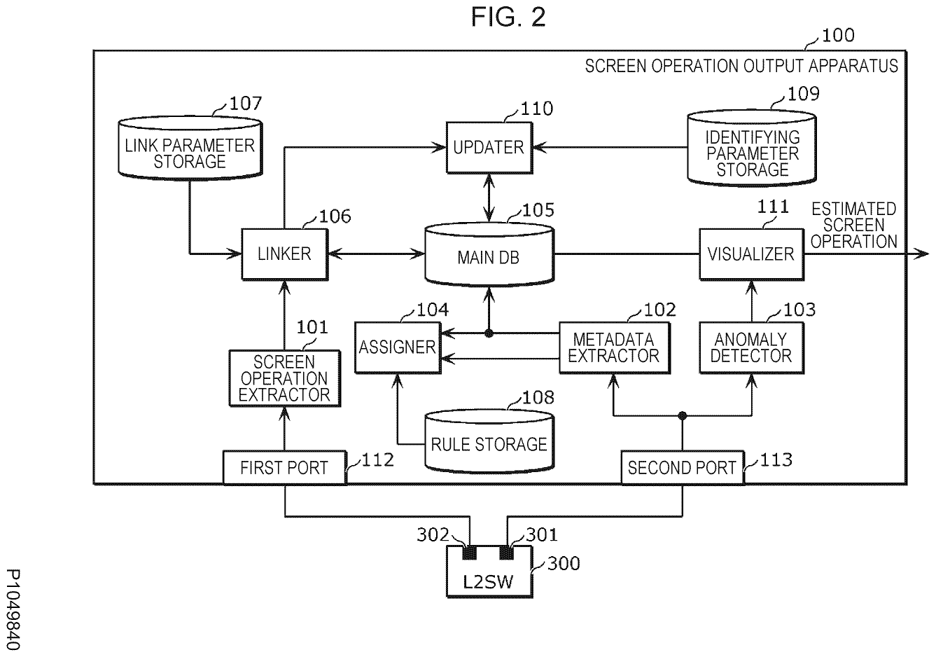

FIG. 2 is a block diagram showing a configuration of the screen operation output apparatus 100 according to the embodiment.

As shown in FIG. 2, the screen operation output apparatus 100 includes a screen operation extractor 101, a metadata extractor 102, an anomaly detector 103, an assigner 104, a main DB 105, a linker 106, a link parameter storage 107, a rule storage 108, an identifying parameter storage 109, an updater 110, a visualizer 111, a first port 112, and a second port 113.

The screen operation output apparatus 100 is implemented, for example, as a computer apparatus including a communication interface, such as a communication circuit, for performing communication, a memory, and a processor that executes a program stored in the memory.

The screen operation extractor 101 is a processor that acquires information based on a screen operation performed on the control PC 200 by the user. That is, the screen operation extractor 101 acquires information (also called “operation information”) pertaining to an operation (screen operation) performed on the control PC 200 by the user operating the control PC 200. Specifically, the screen operation extractor 101 acquires, via the first port 112, information indicating the user's screen operation from the control PC 200.

For example, the screen operation extractor 101 acquires, as operation information, a screenshot (screenshot image) taken at the moment when the user executes a click and at the moment when the user executes key input (input to the keyboard). Specifically, the screen operation extractor 101 acquires operation information containing a screenshot of a screen (operation screen) displayed on the display device of the control PC 200 when the user executes at least either the click of the mouse of the control PC 200 or the input to the keyboard of the control PC 200 as an operation on the control PC 200. For example, upon receiving these operations from the user, the control PC 200 acquires the time of receipt and a screenshot of an operation screen (GUI) displayed at the time and sends them to the screen operation output apparatus 100.

The metadata extractor 102 is a processor that observes via the second port 113 a control packet flowing through the control network. Specifically, the metadata extractor 102 acquires a control packet flowing through the control network. More specifically, the metadata extractor 102 acquires metadata contained in the control packet thus acquired. Specific examples of metadata will be described later.

The anomaly detector 103 is a processor that detects an anomaly in communication observed. Specifically, the anomaly detector 103 detects an anomaly in a control packet flowing through the control network. More specifically, the anomaly detector 103 observes via the second port 113 a control packet flowing through the control network. More specifically, the anomaly detector 103 acquires a control packet flowing through the control network and detects an anomaly in the control packet thus acquired.

The anomaly detector 103 is an example of a detector.

The assigner 104 is a processor that assigns a control type ID to a control packet acquired.

The control type ID is an identifier that is uniquely defined on the basis of information that may be contained in the control packet such as the source IP, destination IP, and command (content of control) of the control packet. The control type ID is arbitrarily defined on the basis of a combination of these pieces of information. Based on data (metadata) contained in a control packet acquired, the assigner 104 allocates a control type ID to the control packet and stores the control type ID in the main DB 105. A specific example of how a control type ID is set will be described later.

The main DB 105 is a storage device in which to store a control packet allocated a control type ID. Specifically, the main DB 105 stores a control type ID table serving as a database in which control type IDs and pieces of data contained in control packets are linked to each other.

The linker 106 is a processor that links a screen operation and a control packet. Specifically, the linker 106 establishes a link between a control packet acquired and operation information. More specifically, the linker 106 links information, extracted by the screen operation extractor 101, that pertains to an operation on the control PC 200 by the user and a plurality of pieces of metadata extracted by the metadata extractor 102 and contained in a control packet. For example, the linker 106 assigns a control type ID to operation information acquired, thereby linking a control packet assigned the same control type ID and the operation information.

For example, in the linking, the linker 106 links a control packet acquired by the metadata extractor 102 and operation information acquired by the screen operation extractor 101 within a particular period of time corresponding to the time of acquisition of the control packet.

It should be noted that the particular period of time may be arbitrarily defined in advance and is not limited in particular.

Further, the control PC 200 may send operation information in link with a control packet. In this case, the linker 106 does not need to establish a link between the control packet and the operation information.

The link parameter storage 107 is a storage device in which to store conditions under which the linker 106 links a screen operation and a control packet. For example, the link parameter storage 107 stores conditions for acquiring a screen operation, a range of differences between the time of acquisition of a screen operation and the time of acquisition of a control packet that is allowed in establishing a link, or other parameters. The screen operation extractor 101 and the linker 106 perform their respective processes, for example, on the basis of the information (conditions) stored in the link parameter storage 107.

The rule storage 108 is a storage device in which to store information (also called “type definition rule”) indicating a definition (rule) of a type of a control packet to be linked to a screen operation. The linker 106 determines, for example, on the basis of the type definition rule, whether a control packet acquired is the control packet to be linked to the screen operation.

The identifying parameter storage 109 is a storage device in which to store information (conditions) for identifying where on an operation screen being displayed on the control PC 200 various types of information on the operation screen are being displayed. For example, the screen operation extractor 101 acquires, as information indicating the user's screen operation, a screenshot of an operation screen displayed on the control PC 200. For example, the updater 110 identifies, on the basis of the conditions stored in the identifying parameter storage 109, where in the screenshot thus acquired a controlling value is shown.

The updater 110 is a processor that estimates, on the basis of operation information linked by the linker 106, a position where a controlling value is displayed. Specifically, the updater 110 identifies where a controlling value is shown in an image (e.g. a screenshot of an operation screen) showing the user's screen operation acquired. More specifically, in a case where a screen operation linked to a control packet assigned a new control type ID is acquired, the updater 110 extracts, from a screen operation information table stored in the main DB 105, a control packet allocated the same control type ID as the control type ID. Furthermore, the updater 110 executes OCR (optical character recognition) on the image showing the screen operation. Furthermore, the updater 110 extracts a place where a numerical value in output obtained by the OCR and a controlling value contained in the control packet match and extracts the position of, for example, a message box in the image in which the numerical value is contained.

In this way, for example, the updater 110 estimates, on the basis of operation information, a position on an operation screen (e.g. the aforementioned screenshot) where a controlling value contained in a control packet to be sent to the PLC 400 and intended to control the PLC 400 is being displayed. For example, in estimating the position where the controlling value is being displayed, the updater 110 estimates, with reference to at least any of output obtained by performing OCR on the screenshot, the coordinates of a position clicked, and information on input to the keyboard, the position where the controlling value is being displayed.

The coordinates of a position clicked refers, for example, to the coordinates of the position, on a GUI (specifically, an operation screen) displayed on the display device by the mouse when the user clicked the mouse, of a mouse pointer that moves on the GUI. The information on input to the keyboard is, for example, information indicating what input has been done to the keyboard and where on the operation screen the input has been done (e.g. whether the Enter key has been pressed or whether a numerical value has been inputted).

The visualizer 111 is a processor that visualizes an operation screen that is responsible for the generation of an anomalous packet. Specifically, when the anomaly detector 103 has detected an anomaly in a control packet, i.e. when the anomaly detector 103 has detected an anomalous control packet, the visualizer 111 visualizes an operation screen estimated to generate the anomalous control packet thus detected. That is, in a case where an anomaly in a control packet has been detected, the visualizer 111 outputs, on the basis of the packet, an operation screen estimated to generate the packet. For example, if the control PC 200 has sent the anomalous packet via the network, the visualizer 111 outputs an image (also called “estimation image”) of an operation screen estimated to have been displayed on the control PC 200 when the control PC 200 received from the user an operation that causes the control PC 200 to send the anomalous packet. The estimation image is an image based on a screenshot of the operation screen displayed on the control PC 200.

For example, in a case where the user has mistakenly caused the control PC 200 to send an anomalous control packet, an operation screen estimated to have been displayed on the control PC 200 when the control PC 200 sent the control packet is outputted. However, in a case where an operator (attacker) other than the control PC 200 has sent a control packet without using an operation screen, no operation screen is generated. Accordingly, in view of both of these cases, the visualizer 111 estimates and outputs an operation screen assumedly used to send an anomalous control packet.

The visualizer 111 is an example of an output.

For example, the visualizer 111 outputs, on the basis of a control packet and operation information linked to each other by the linker 106, an operation screen estimated to generate an anomalous control packet.

For example, in a case where the visualizer 111 has not acquired operation information linked to a control packet of an identical type to a control packet in which an anomaly was detected, the visualizer 111 outputs an estimation image (i.e. the operation screen estimated to generate the anomalous control packet) on the basis of metadata contained in the control packet in which the anomaly was detected. For example, the visualizer 111 extracts, on the basis of, for example, a control type ID determined on the basis of the metadata contained in the control packet in which the anomaly was detected, a control packet that is similar to the control packet, estimates, with the use of a screenshot contained in operation information linked to the control packet thus extracted, an operation screen displayed when the control packet in which the anomaly was detected is sent, and outputs the operation screen thus estimated. For example, the visualizer 111 outputs an operation screen generated by replacing, with the metadata contained in the control packet in which the anomaly was detected, a place where metadata is displayed in the screenshot contained in the operation information linked to the control packet thus extracted.

Whether control packets are similar to each other may be determined on the basis of a criterion arbitrarily defined in advance and is not limited to particular criteria for determination. For example, control packets containing types of metadata that at least partially match each other are selected as similar control packets.

Further, for example, in a case where the visualizer 111 has acquired the operation information linked to the control packet of the identical type to the control packet in which the anomaly was detected, the visualizer 111 outputs, as the operation screen estimated to generate the anomalous control packet, a screenshot contained in operation information linked to the control packet of the identical type.

Whether control packets are identical to each other may be determined on the basis of a criterion arbitrarily defined in advance and is not limited to particular criteria for determination. For example, control packets containing types of metadata that match each other or control packets allocated the same control type ID are selected as identical control packets.

Further, in outputting the operation screen estimated to generate the anomalous control packet, the visualizer 111 may output an operation screen with emphasis on the position where the controlling value is being displayed. For example, in a case where a control packet is determined by the anomaly detector 103 to be anomalous because the control packet contains an anomalous controlling value, the visualizer 111 may generate an operation screen highlighting a place where the controlling value is being displayed.

The highlighting needs only be such a display as to be different from other places and is not limited to particular modes of display. The highlighting may be a change of color of the position where the controlling value is being displayed, a change such as placing the controlling value in a frame, or may be a process of causing the controlling value to blink when displayed.

The first port 112 is a communication interface, connected to the normal port 302, through which a control packet is acquired. The first port 112 is implemented, for example, as a connector to which a communication line is connected. Alternatively, the first port 112 may be implemented, for example, as a communication circuit for performing wireless communication.

The second port 113 is a communication interface, connected to the mirror port 301, through which a control packet is acquired. The second port 113 is implemented, for example, as a connector to which a communication line is connected. Alternatively, the second port 113 may be implemented, for example, as a communication circuit for performing wireless communication.

The processors such as the screen operation extractor 101, the metadata extractor 102, the anomaly detector 103, the assigner 104, the linker 106, the updater 110, and the visualizer 111 are implemented, for example, by a memory in which a control program is stored and a processor, such as a CPU (central processing unit), that executes the control program. The processors may be implemented by one memory and one processor or may each be implemented by separate memories and separate processors.

The storage devices such as the main DB 105, the link parameter storage 107, the rule storage 108, and the identifying parameter storage 109 are implemented, for example, by storage devices such as HDDs (hard disk drives) or semiconductor memories. The storage devices may be implemented by one storage device or may each be implemented by separate storage devices.

In the following, processes that are performed by the processors of the screen operation output apparatus 100 are described in concrete terms.

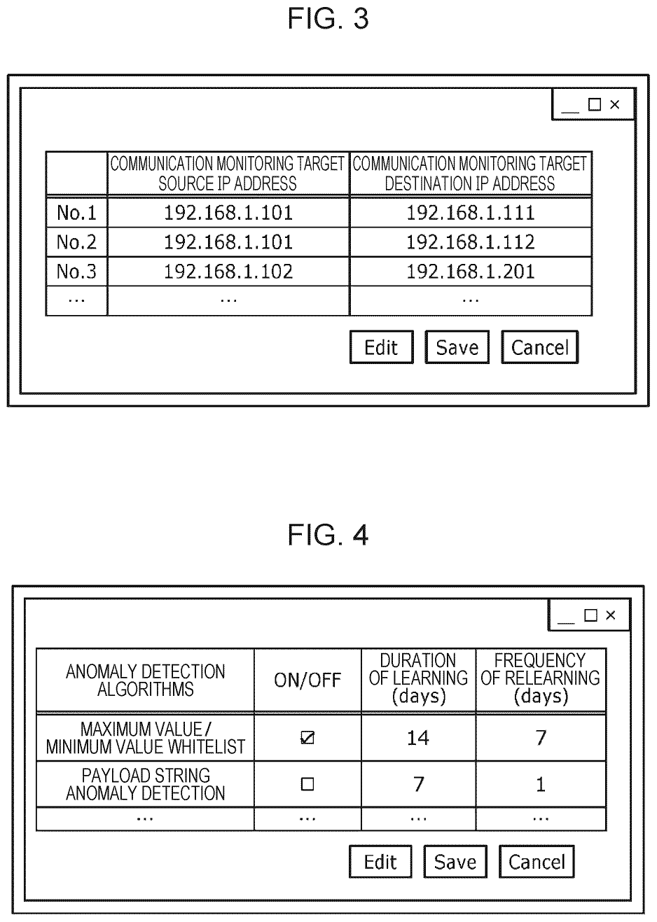

FIG. 3 is a diagram showing pair information of IP addresses to be subjected to screen operation estimation by the screen operation output apparatus according to the embodiment. Specifically, FIG. 3 shows communication monitoring target IP addresses that are utilized by the linker 106. For example, FIG. 3 shows the IP addresses of apparatuses to be monitored by the screen operation output apparatus 100. Configuration information indicating IP addresses such as these is stored in advance, for example, in a storage device of the screen operation output apparatus 100.

Packets linked to screen operations to be stored and visualized by the screen operation output apparatus 100 are limited solely to communication between the IP addresses shown in FIG. 3.

FIG. 4 is a diagram showing configuration information of anomaly detection algorithms that are utilized by the anomaly detector 103 according to the embodiment.

As shown in FIG. 4, the anomaly detector 103 retains algorithms that are utilized for packet anomaly detection and configuration parameters thereof and executes a learning process and an anomaly detection process according to the configuration.

For example, a user of the screen operation output apparatus 100 makes entries as to whether algorithms such as a maximum value/minimum value whitelist and payload string anomaly detection are used as the anomaly detection algorithms that are used by the anomaly detector 103 and enters, for example, the duration of learning during which to execute those algorithms and the frequency of relearning.

Instead of these methods, the anomaly detector 103 may use any method to detect an anomaly in a packet.

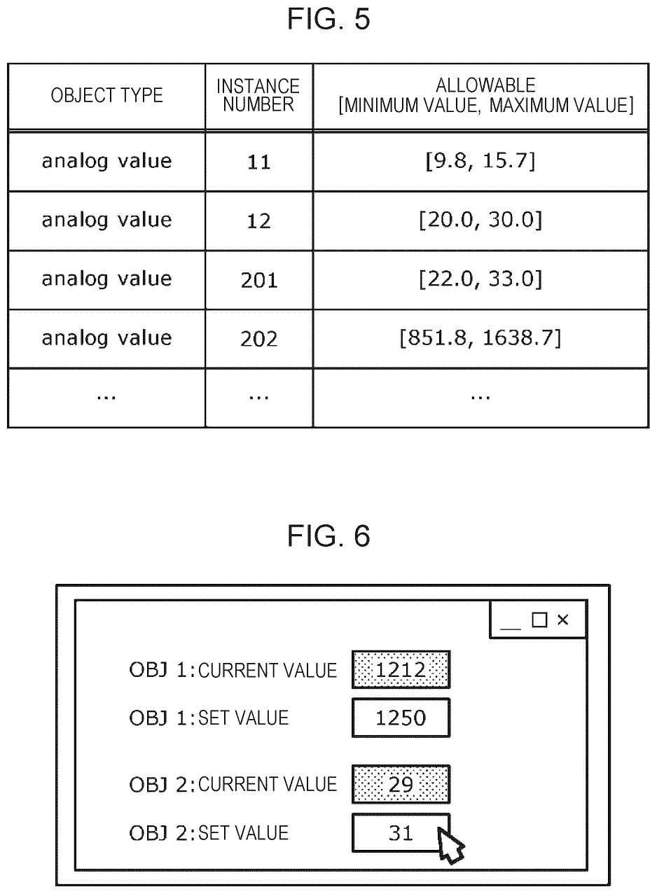

FIG. 5 is a diagram showing a maximum value/minimum value whitelist serving as one of the anomaly detection algorithms that are utilized by the anomaly detector 103 according to the embodiment. Specifically, FIG. 5 shows examples of parameters that the anomaly detector 103 stores in a case where the maximum value/minimum value whitelist is used as the anomaly detection algorithms.

As shown in FIG. 5, in a case where the maximum value/minimum value whitelist is used as the anomaly detection algorithms, object types, instance numbers, and allowable ranges of values are stored in advance in the storage device of the screen operation output apparatus 100. For example, in a case where a control packet whose corresponding object type and instance number are notified or a control packet for writing is acquired and when the value of the control packet deviates from an allowable range of values, the anomaly detector 103 detects the control packet as an anomaly.

The object type is information indicating what value is handled.

The instance number is information set for each object to indicate the order of objects.

FIG. 6 is a diagram showing an image extracted by the screen operation extractor 101 according to the embodiment. In other words, FIG. 6 shows an example of operation information (screen operation information) that is extracted by the screen operation extractor 101.

As shown in FIG. 6, it is assumed herein that the control system 10 is controlled through a screen operation. Accordingly, it is assumed that the control PC 200 displays an operation screen that shows, for example, items to be controlled and set values such as controlling values. A possible example of a method for acquiring a screen operation is to install a key logger in the control PC 200 to cause the control PC 200 to capture an operation screen at a timing when a screen operation should be acquired and send the operation screen to the screen operation output apparatus 100.

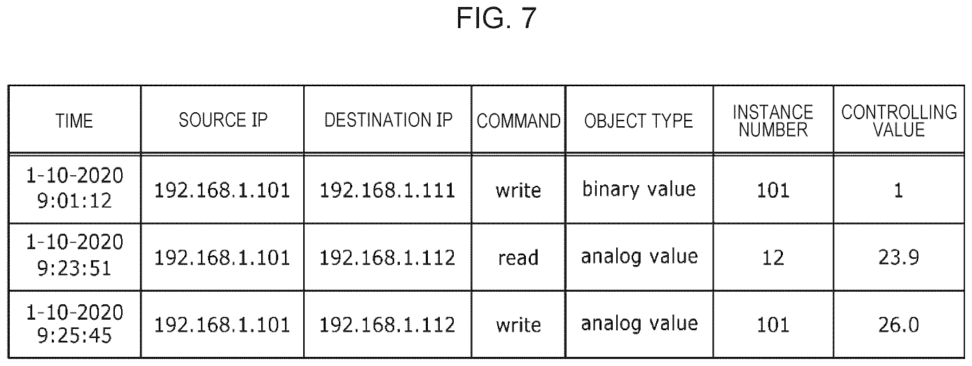

FIG. 7 is a diagram showing metadata (packet metadata) extracted by the metadata extractor 102 according to the embodiment.

As shown in FIG. 7, metadata contained in control packets include information such as times, source IP addresses, destination IP addresses, command types, types of objects to be controlled (object types), the instance numbers of the objects, and controlling values acquired.

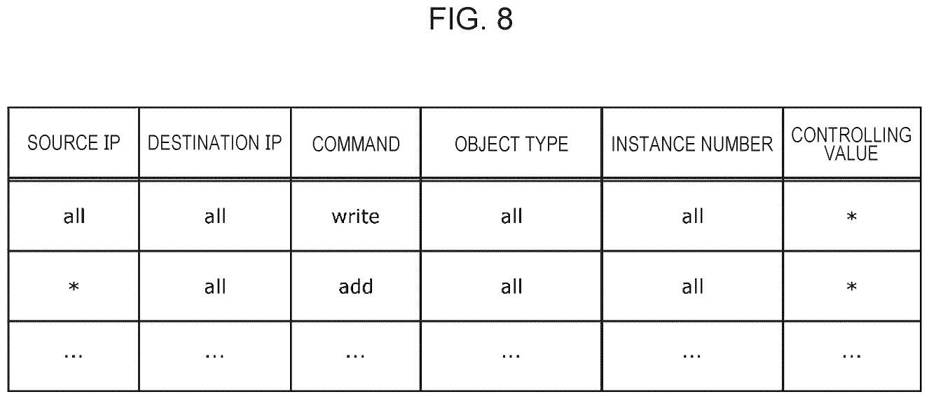

FIG. 8 is a diagram showing type definition rules for control packets according to the embodiment. Specifically, FIG. 8 is a diagram showing examples of type definition rules stored in the rule storage 108 for control packets to be linked to screen operations.

As shown in FIG. 8, only control packets whose command types are, for example, write or add are to be linked to screen operations. The assigner 104 allocates control type IDs, for example, according to these type definition rules.

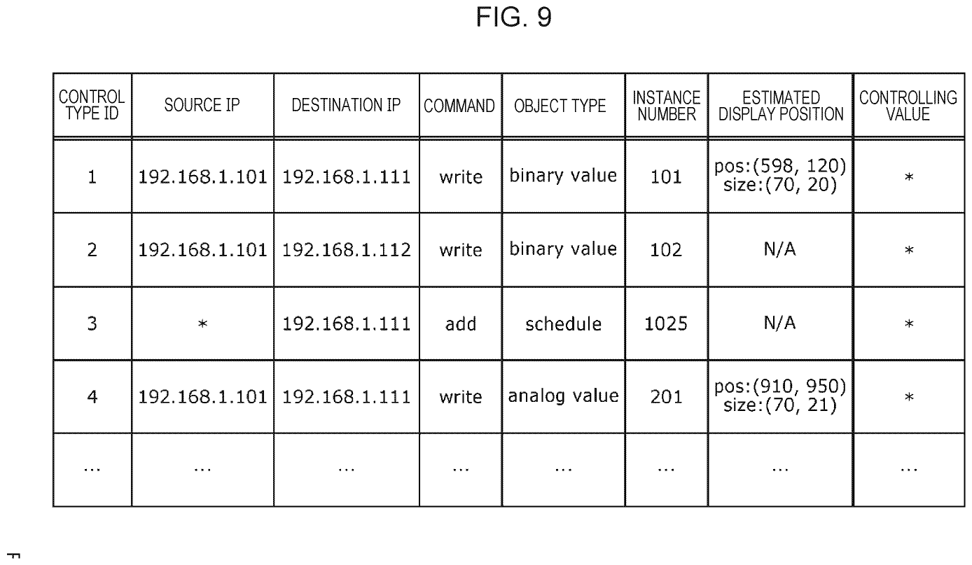

Both all and *, which are shown in FIG. 8, are the same in that a control packet of any parameter of that attribute is to be linked to a screen operation. all means that all values of that parameter are handled with distinction. Meanwhile, * means that all values of that parameter are handled without distinction. This results in differences in a control type ID table shown in FIG. 9.

The rule definition rules are set forth, for example, in (A) and (B) below.

(A) When a control packet acquired satisfies any condition of the type definition rules and a control type ID to which the control packet corresponds has not been allocated to the control packet yet (e.g. when there is no one control type ID yet), the assigner 104 newly generates a control type ID and links, to the control type ID, an attribute value (each piece of metadata contained in the control packet) of the control packet acquired.

(B) When a control packet acquired satisfies any conditions of the type definition rules for control packets, the assigner 104 simply allocates the control type ID to the control packet (more specifically, each piece of metadata contained in the control packet).

Note, however, that the aforementioned type definition rules are based on the premise that they do not match conditions linked to a plurality of control type IDs.

A control type ID may be arbitrarily defined in advance, for example, on the basis of a combination of these pieces of information.

FIG. 9 is a diagram showing a control type ID table stored in the main DB 105 in correspondence with a screen operation according to the embodiment. Specifically, FIG. 9 is a diagram showing a control type ID table, stored in the main DB 105, that is generated according to the aforementioned type definition rules.

As shown in FIG. 9, a control type ID is added every time a control packet of a newly acquired attribute that satisfies the type definition rules is acquired.

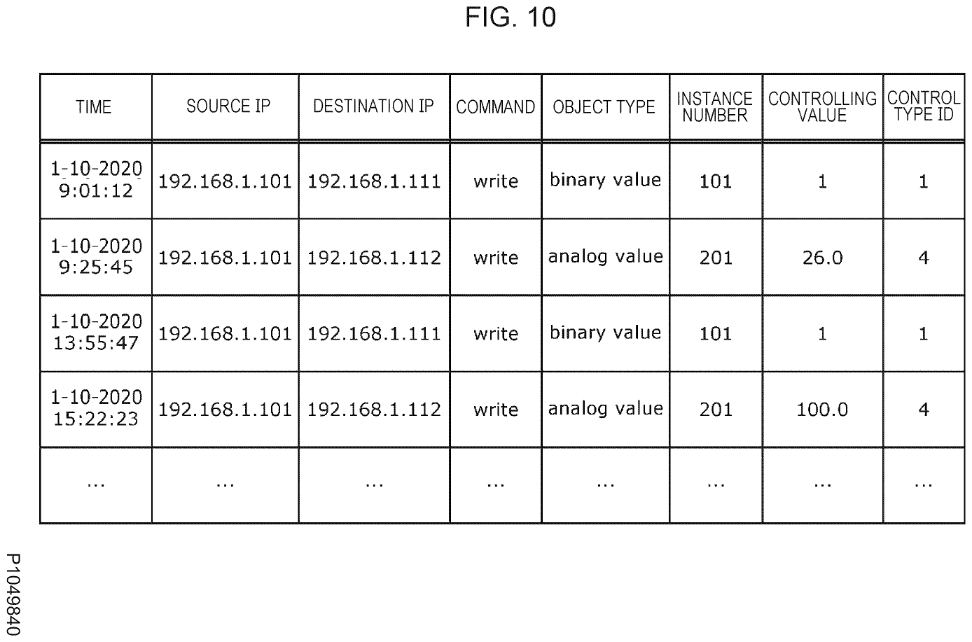

FIG. 10 is a diagram showing a packet metadata table stored in the main DB 105 in correspondence with a screen operation according to the embodiment. Specifically, FIG. 10 is a diagram showing a packet metadata table containing control type IDs to which control packets belong.

With reference to the control type ID table stored in the main DB 105, the assigner 104 assigns, to metadata contained in each control packet extracted by the metadata extractor 102, a control type ID of the control packet and returns the control type ID to the main DB 105. The main DB 105 updates the packet metadata table by assigning, to metadata contained in a control packet whose control type ID is unknown, a control type ID given from the assigner 104.

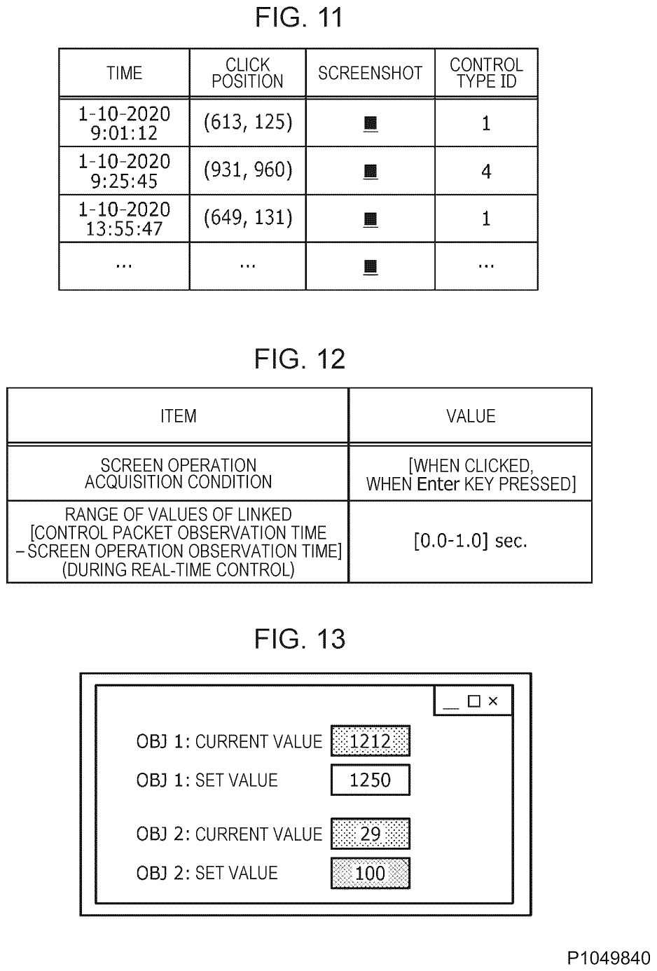

FIG. 11 is a diagram showing a screen operation information table stored in the main DB 105 in correspondence with a screen operation according to the embodiment.

When a screen operation (operation information) linked to a control packet contained in the packet metadata table has been extracted, the linker 106 adds a new record to the screen operation information table shown in FIG. 11 and records, in link with each other, a control type ID and the operation information indicating the screen operation. By so doing, the linker 106 links control packets assigned the same control type ID and the operation information. Further, in this way, the operation information is contained, for example, in the screen operation information table.

FIG. 12 is a diagram showing the contents of link configuration parameters according to the embodiment. Specifically, FIG. 12 is a diagram showing the settings that the linker 106 uses in establishing a link between a control packet and a screen operation.

The screen operation extractor 101 acquires a screen operation of the control PC 200 in accordance with a screen operation acquisition condition shown in FIG. 12. Further, for example, the allowable range of differences between the time of acquisition of a control packet to be linked by the linker 106 (control packet observation time) and the time of acquisition of a screen operation to be linked (screen operation observation time) is set in advance.

In the example shown in FIG. 12, when the control PC 200 has been clicked by the user or the Enter key of the keyboard has been pressed, the screen operation extractor 101 acquires, as operation information, a screenshot of an operation screen displayed on the control PC 200 at that time and information indicating the time at which such an operation was done. For example, the control PC 200 is set in advance to send operation information at such a time.

Further, in the example shown in FIG. 12, the linker 106 establishes a link between the control packet and the operation information if a value obtained by subtracting the screen operation observation time from the control packet observation time falls within a range of 0.0 to 1.0 seconds and does not establish a link between the control packet and the operation information if the value does not fall within the range of 0.0 to 1.0 seconds.

The screen operation output apparatus 100 and the control PC 200 may include a time measurer such as an RTC (real-time clock).

FIG. 13 is a diagram showing an example of an operation screen that is outputted by the visualizer 111 when the anomaly detector 103 according to the embodiment has detected an anomalous packet.

As shown in FIG. 13, in a case where the anomaly detector 103 has detected an anomalous control packet, the visualizer 111 extracts, from the packet metadata table stored in the main DB 105, metadata pertaining to the control packet in which the anomaly was detected.

After that, the visualizer 111 identifies a source IP, a destination IP, a command type, an object type, and an instance number from the metadata contained in the control packet in which the anomaly was detected.

Furthermore, the visualizer 111 extracts, from the control type ID table, an estimated value (estimated display position) of positional information of an operation screen that is responsible for the generation of a control packet containing these pieces of attribute information (metadata).

Furthermore, the visualizer 111 acquires, from the screen operation information table, a screen operation on the control type ID and outputs a replacement of an operation screen (such as a screenshot) for the control type ID with the replacement highlighted with a value of observation of a place represented by the estimated display position (i.e. a value contained in the control packet).

For example, in a case where OBJ2: SET VALUE in FIG. 13 corresponds to (object type, instance number)=(analog value, 201) and when a control packet that writes the value 100 into (analog value, 201) is acquired, a deviation from the maximum value of the maximum value/minimum value whitelist shown in FIG. 5 is detected. Since it is known from the control type ID table shown in FIG. 9 that this control packet corresponds to Control Type ID=4 and the estimated display position is pos: (910, 950) size: (70, 21), a controlling value is highlighted displayed in this position.

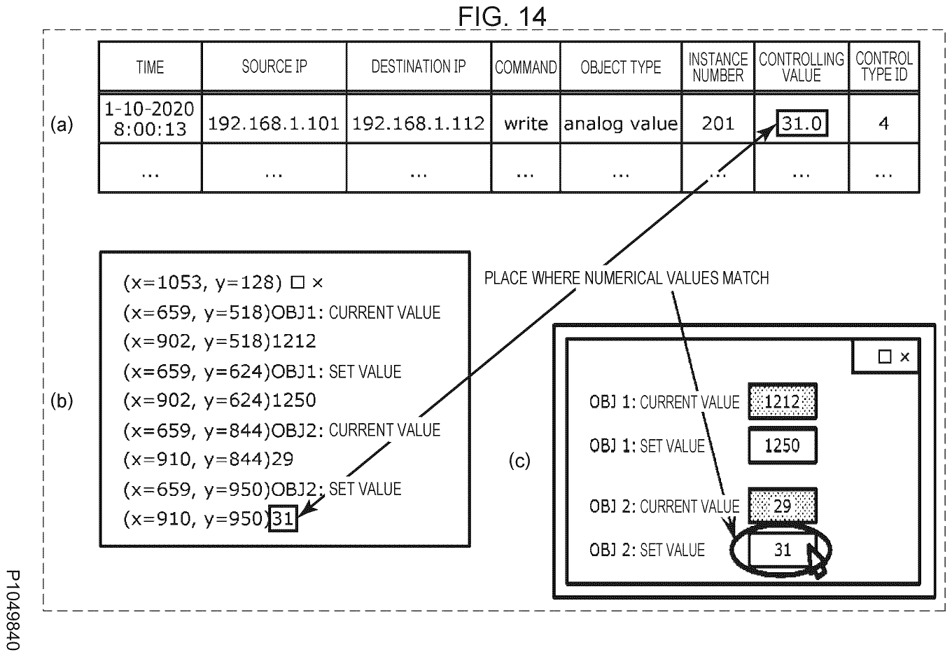

FIG. 14 is a diagram showing a method for acquiring an estimated display position for each control type ID stored in the main DB 105. Specifically, FIG. 14 is a diagram showing a method by which the updater 110 estimates a position that is highlighted by the visualizer 111 according to the embodiment as a place where an anomalous screen operation is being done and the position of a text box. (a) of FIG. 14 is an example of information contained in the packet metadata table. (b) of FIG. 14 is an example of output that is obtained by executing OCR on the screenshot contained in operation information acquired. (c) of FIG. 14 is an example of a screenshot contained in the operation information acquired.

For example, in a case where operation information linked to a control packet of a particular control type ID has been newly acquired by the linker 106, the updater 110 extracts, from the screen operation information table stored in the main DB 105, a control packet to which the control type ID is linked. Further, for example, the updater 110 executes OCR on a screenshot contained in the operation information, extracts a place where a controlling value and the output of OCR match, and extracts a message box in which a value shown in the place is contained. By so doing, the updater 110 extracts, in the screenshot contained in the operation information, a position (specifically, coordinates) where the controlling value contained in the control packet is shown. Further, the screenshot is also used, for example, as an operation screen that is outputted by the visualizer 111. That is, by extracting, in the screenshot contained in the operation information, the position where the controlling value contained in the control packet is shown, the updater 110 extracts, on an operation screen estimated to generate an anomalous control packet, a position where the controlling value is shown.

In the example shown in FIG. 14, the updater 110 acquires, from the packet metadata table, a controlling value (in the present example, 31.0) contained in a corresponding control packet. Next, the updater 110 identifies, from among the output of OCR, a value (in the present example, 31) that is equal to the controlling value thus acquired. Next, by acquiring the coordinates (in the present example, x=910, y=950) of the value thus identified, the updater 110 identifies a position in the screenshot where the controlling value is shown.

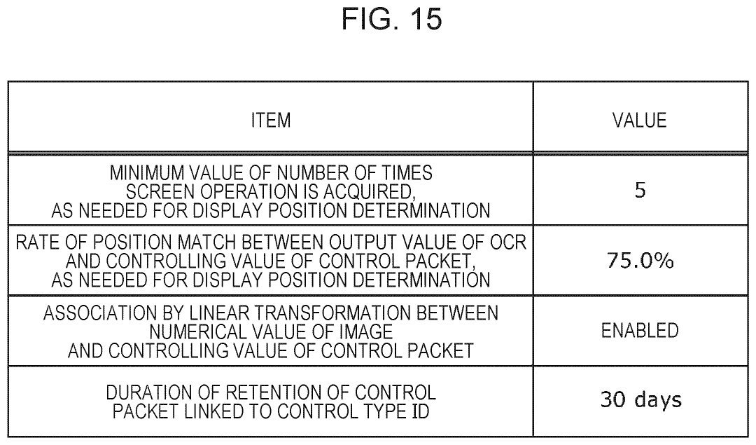

FIG. 15 is a diagram showing the contents of display position-identifying configuration parameters according to the embodiment.

For example, the updater 110 identifies, on the basis of conditions shown in FIG. 15, a position in a screenshot where a controlling value is shown.

The column “ITEM” shows the conditions, and the column “VALUE” shows values for determining whether the corresponding conditions are satisfied.

For example, in the case of a determination as to whether the condition “MINIMUM VALUE OF NUMBER OF TIMES SCREEN OPERATION IS ACQUIRED, AS NEEDED FOR DISPLAY POSITION DETERMINATION” shown in the column “ITEM” is satisfied, the updater 110 determines whether operation information linked to the corresponding control packet has been acquired five or more times. For example, in a case where the operation information linked to the corresponding control packet has been acquired five or more times, the updater 110 identifies, as noted above, the position in the screenshot where the controlling value is shown. On the other hand, in a case where the operation information linked to the corresponding control packet has not been acquired five or more times, the updater 110 does not identify the position with the operation information.

In extracting a place (e.g. a message box) where a controlling value and the output of OCR match, the updater 110 may extract the position of the message box thus extracted not from only one piece of screen operation information but from among pieces of operation information that satisfy the number of times that is greater than or equal to the minimum value shown in FIG. 15 of the number of times a screen operation is acquired and determine the display position only in a case where the place has been extracted from operation information whose identical coordinates have a predetermined or higher rate of position match. This makes it possible to increase the certainty.

The predetermined rate of position match is the rate of match between a controlling value contained in a control packet and a numerical value in the output of OCR. The predetermined rate of position match may be arbitrarily defined and is not limited in particular.

Further, even in a case where the same controlling values are shown in actuality, a value shown in a screenshot and a controlling value contained in a control packet are not always identical in value to each other. For example, there is a possibility that a constant multiple of a value shown in a screenshot may be a controlling value contained in a control packet. Therefore, also in a case where a and b between which the relationship Y=aX+b (where a and b are, for example, integers) holds are present for a value (e.g. X) contained in a screenshot and a controlling value (e.g. Y) contained in a control packet, the position of the controlling value may be identified on the assumption that X and Y are the same value.

### Procedure

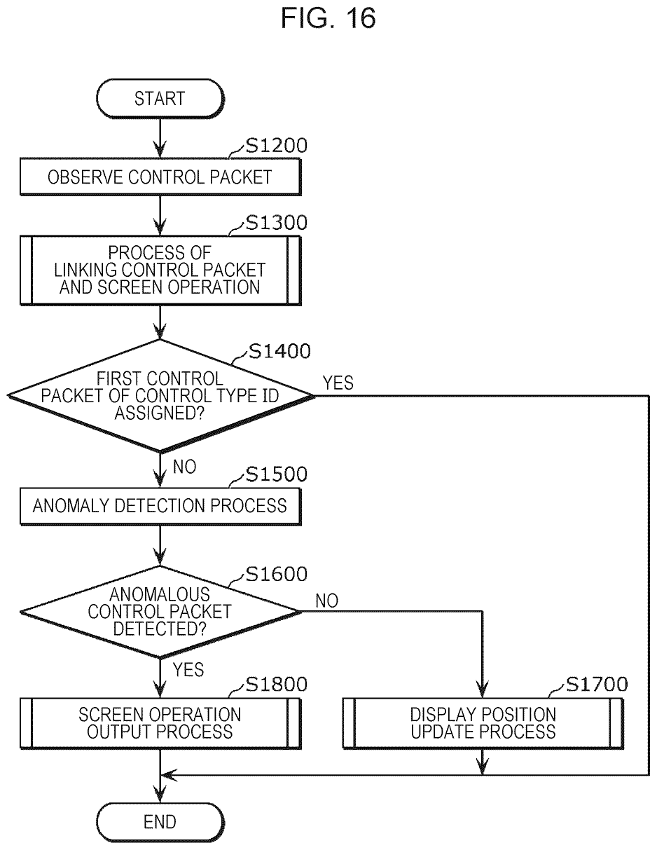

FIG. 16 is a flow chart showing an overview of a process of the screen operation output apparatus 100 according to the embodiment.

As shown in FIG. 16, first, upon starting a screen operation output process, the screen operation output apparatus 100 starts an observation of a control packet (S1200). For example, the screen operation extractor 101 and the metadata extractor 102 start the acquisition of a control packet flowing through the control network and operation information.

Next, the assigner 104 and the linker 106 execute a process of linking a control packet observed and a screen operation (operation information) (S1300).

Next, the assigner 104 determines whether the control packet observed this time is the first control packet of a control type ID assigned (S1400). That is, the assigner 104 determines whether the control type ID assigned is a control type ID first assigned.

In a case where the assigner 104 determines that the control packet observed this time is the first control packet of the control type ID assigned (YES in S1400), the process is ended. In this case, the screen operation output apparatus 100 waits until a next control packet is observed.

On the other hand, in a case where the assigner 104 determines that the control packet observed this time is not the first control packet of the control type ID assigned (NO in S1400), i.e. in a case where the control type ID was assigned to the control packet thus observed in the past, the anomaly detector 103 executes an anomaly detection process on the control packet thus observed (S1500).

In a case where the anomaly detector 103 detects an anomalous control packet (YES in S1600), i.e. in a case where the control packet thus observed is anomalous, the screen operation output apparatus 100 executes the screen operation output process (S1800).

On the other hand, in a case where the anomaly detector 103 does not detect an anomalous control packet (NO in S1600), i.e. in a case where the control packet thus observed is not anomalous, the screen operation output apparatus 100 executes a display position update process (S1700).

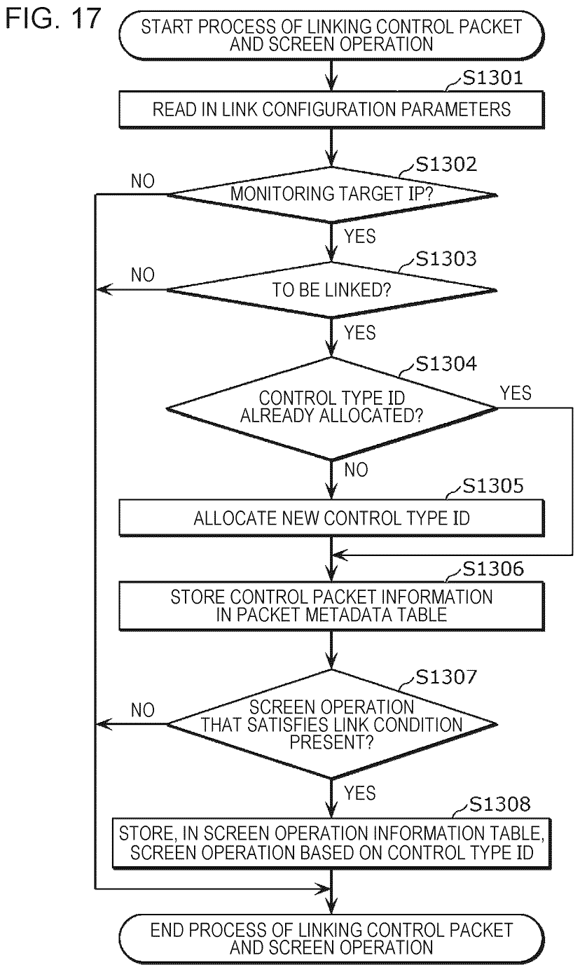

FIG. 17 is a flow chart of a process of linking a control packet and a screen operation according to the embodiment. Specifically, FIG. 17 is a flow chart showing details of the process of step S1300.

As shown in FIG. 17, first, upon starting the process of linking a control packet and a screen operation, the assigner 104 reads in link configuration parameters of a control packet and a screen operation as shown in FIG. 12 (S1301). In this step, conditions for acquiring a screen operation, a range of differences between the time of acquisition of operation information and the time of observation of a control packet that is allowed in establishing a link, or other parameters are read in.

Next, the assigner 104 determines whether the control packet observed in step S1200 is communication between monitoring target IP addresses contained in the communication monitoring target IP address information shown in FIG. 3 (S1302).

Next, in a case where there is a pair of monitoring target IP addresses (YES in S1302), the assigner 104 determines, on the basis of the type definition rules shown in FIG. 8, whether the control packet thus observed is a control packet to be linked to the screen operation (S1303).

In a case where the assigner 104 determines that the control packet thus observed is a control packet to be linked to the screen operation (YES in S1303), the assigner 104 determines whether a control type ID has already been allocated to the control packet (S1304).

In a case where a control type ID has not been allocated to the control packet yet (NO in S1304), the assigner 104 allocates a new control type ID and updates the control type ID table shown in FIG. 9 (S1305).

In a case where a control type ID has already been allocated to the control packet (YES in S1304) or after step S1305, the assigner 104 stores, in the packet metadata table shown in FIG. 10, information such as metadata contained in the packet thus observed (S1306).

Next, the linker 106 determines whether there is a screen operation that satisfies a link condition shown in the link configuration parameters (S1307).

In a case where there is such a screen operation (YES in S1307), the linker 106 stores, in the screen operation information table shown in FIG. 11, a screen operation linked to the control type ID (S1308), and the process is ended.

Further, in the case of NO in step S1302, in the case of NO in step S1303, or in the case of NO in step S1307, the screen operation output apparatus 100 ends the linking process.

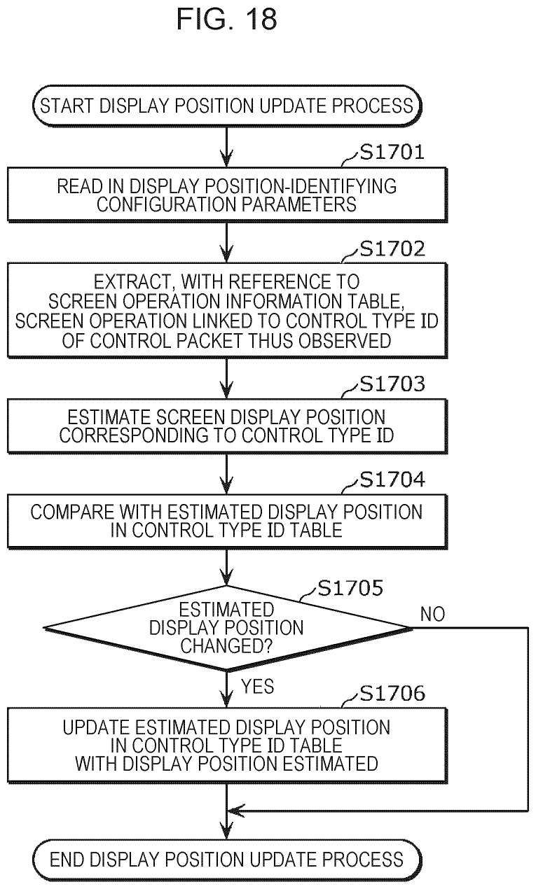

FIG. 18 is a flow chart of a display position update process according to the embodiment. Specifically, FIG. 18 is a flow chart showing details of the process of step S1700.

As shown in FIG. 18, first, upon starting the display position update process, the updater 110 reads in the display position-identifying configuration parameters shown in FIG. 15 (S1701). These configuration parameters are parameters indicating conditions under which a controlling value and a display position are linked to each other in a case where a link between a control packet and a screen operation is established.

Next, the updater 110 extracts, with reference to the screen operation information table shown in FIG. 11, a screen operation linked to the control type ID of the control packet thus observed (S1702). For example, the updater 110 extracts, from the screen operation information table, a screen operation linked to the control type ID of the control packet thus observed. In this step, a plurality of past screen operations linked to an identical control type ID are to be extracted.

Next, the updater 110 performs a process of estimating a screen display position corresponding to the control type ID (S1703). Possible examples of the method for estimating a display position include a method such as, as shown in FIG. 14, finding out a place where a controlling value contained in a control packet and text data obtained by OCR of screen operation information (screenshot) match and extracting a text box in which the value is displayed. Further, in a case where a plurality of screen operations are extracted, possible examples include a method such as executing an identical process on each screen operation and employing the mean of the center positions of text boxes extracted separately in correspondence with each screen operation or the median of the sizes of the text boxes.

Next, the updater 110 makes a comparison between an estimated display position already described in the control type ID table and the display position estimated in step S1703 (S1705).

In a case where the estimated display position already described in the control type ID table and the display position estimated in step S1703 are different from each other (YES in S1705), the updater 110 makes an update as there is a change in the estimated display position (S1706). Specifically, the updater 110 updates the estimated display position of the control type ID table with the display position estimated in step S1703.

On the other hand, in a case where the estimated display position already described in the control type ID table and the display position estimated in step S1703 are identical to each other (NO in S1705) or after step S1706, the screen operation output apparatus 100 ends the display position update process.

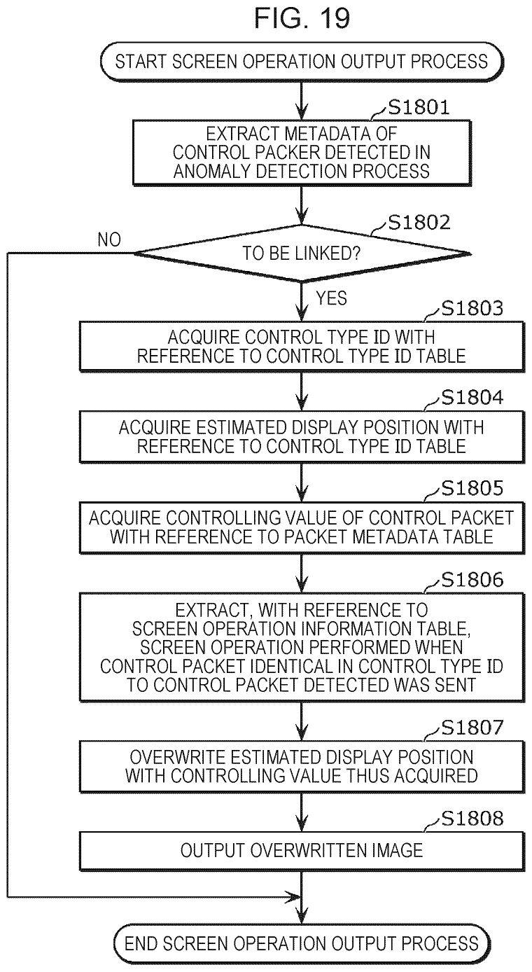

FIG. 19 is a flow chart of a screen operation output process according to the embodiment. Specifically, FIG. 19 is a flow chart showing details of the process of step S1800.

As shown in FIG. 19, first, upon starting the screen operation output process, the metadata extractor 102 extracts metadata contained in the control packet in which the anomaly was detected in the anomaly detection process (S1801).

In a case where the updater 110 determines that this control packet is not a control packet to be linked to the screen operation (NO in S1802), the screen operation output apparatus 100 ends the screen operation output process.

On the other hand, in a case where this control packet is a control packet to be linked to the screen operation (YES in S1802), the updater 110 acquires the control type ID of the control packet with reference to the control type ID table shown in FIG. 9 (S1803).

Next, the updater 110 acquires, with reference to the control type ID table, information (positional information) indicating a position (estimated display position) where a controlling value contained in the control packet is estimated to be shown (S1804).

Next, the updater 110 acquires, with reference to the packet metadata table shown in FIG. 10, the controlling value contained in the control packet thus observed (S1805).

Next, the updater 110 extracts, with reference to the screen operation information table, a screen operation performed when a control packet identical in control type ID to the control packet in which the anomaly was detected was sent (S1806). For example, the visualizer 111 extracts, from the screen operation information table shown in FIG. 11, a screen operation acquired at a time closest to the current time (specifically, the time at which the process is being executed) of screen operations (screenshots) performed when the identical control type ID was controlled.

Next, the updater 110 generates an image (estimation image) in which an image of a place where the controlling value is estimated to be being displayed in the screen operation (screenshot) thus acquired is highlighted as shown in FIG. 13 with the controlling value acquired in step S1805 (S1807). That is, the updater 110 generates an image in which the controlling value being displayed in the screenshot is overwritten with the controlling value contained in the control packet.

Next, the visualizer 111 outputs, as an operation screen (i.e. an estimation image) estimated to generate the packet in which the anomaly was detected, the image in which the controlling value is highlighted (i.e. an image in which the controlling value is overwritten) (S1808).

### Conclusion

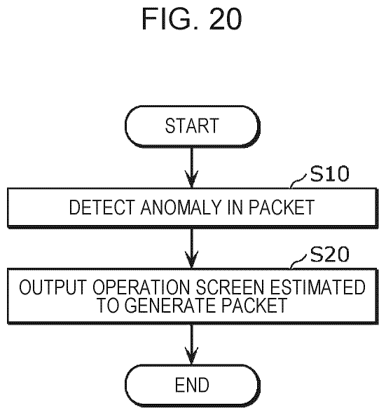

FIG. 20 is a flow chart showing an information processing method that is executed by an information processing apparatus according to the embodiment.

The information processing apparatus is, for example, the aforementioned screen operation output apparatus 100.

First, the information processing apparatus detects an anomaly in a packet flowing through a network (S10). Specifically, the information processing apparatus detects an anomaly in a packet that is sent to a controlled apparatus in the network. The network is, for example, the aforementioned control network. The controlled apparatus is, for example, the aforementioned PLC 400. The packet is, for example, the aforementioned control packet and is a packet that is sent to the controlled apparatus to control the controlled apparatus. For example, the information processing apparatus detects an anomaly in a packet by acquiring (observing) a packet in a network to which the controlled apparatus is connected and determining whether there is an anomaly in the packet thus acquired.

Next, in a case where the anomaly in the packet is detected, the information processing apparatus outputs, on the basis of the packet, an operation screen estimated to generate the packet (S20).

The operating apparatus is, for example, the aforementioned control PC 200.

The user sends a packet to the controlled apparatus by operating the operating device. In so doing, the user sends a packet to the controlled apparatus, for example, by performing, with the input device, an operation of, while looking at a GUI (operation screen) displayed on the display device, for example, clicking the mouse so as to select an icon such as a send button on the GUI.

Incidentally, there is a possibility, for example, that a malicious third person may send, to the controlled apparatus, a packet that causes the controlled apparatus to exercise anomalous control. Further, there is a possibility, for example, that a packet sent from the operating device may be falsified to cause the controlled apparatus to exercise anomalous control and sent to the controlled apparatus. The information processing apparatus detects such an anomalous packet.

Note here that in a case where an anomalous packet has been detected, i.e. if a packet has been sent from the operating device to the controlled apparatus when an anomaly in the packet has been detected, the information processing apparatus outputs an operation screen estimated to have been displayed at a timing when the operating device sent the packet. The information processing apparatus visualizes the operation screen, for example, by outputting the operation screen to the operating device to cause the display device of the operating device to display the operation screen.

For example, in a case where a screen operation that generates an anomalous packet is actually being performed by the user, the information processing apparatus reproduces the screen operation and then highlights an important point. In such a case, for example, the information processing apparatus outputs an image (screenshot) of a GUI that is an operation screen on which the screen operation was performed.

Alternatively, for example, in a case where a screen operation that generates an anomalous packet is not actually being performed by the user, the information processing apparatus simulatively reproduces an operation screen (image) that generates the packet, and highlights an important point. In such a case, for example, the information processing apparatus outputs, as the operation screen, an image (screenshot) on which the screen operation is performed when a packet of an identical type to the packet is sent.

Conventionally, detection of an anomaly at a communication level is an effective way of performing cybersecurity monitoring. However, it is difficult to grasp a possible effect on the system by a detected event.

Note here that in a case where the information processing apparatus has detected anomalous communication, the information processing apparatus can visualize a screen operation that generates the communication.

Accordingly, since the information processing apparatus can make it easy to grasp a screen operation (GUI operation) that generates a packet detected as anomaly, the information processing apparatus makes it possible to efficiently conduct an analysis or other examinations at an SOC (security operation center). Further, even in the case of a packet that does not originate from the user's screen operation, such as an attacker's packet, a screen operation that can generate the packet can be grasped. This can make it easy to rapidly grasp the effect of the attack by the packet.

The information processing apparatus may send an operation screen to the operating device, to a display device connected to the information processing apparatus, or to a device that analyzes a packet.

The information processing apparatus includes, for example, a processor and a memory, and the processor uses the memory to perform the aforementioned information processing method.

### Effects

The following illustrates technologies obtained from the content of the present disclosure and describes effects brought about by the technologies illustrated.

Technology 1 is directed to an information processing method including: detecting an anomaly in a packet flowing through a network (S10); and in a case where the anomaly in the packet is detected, outputting, on the basis of the packet, an operation screen estimated to generate the packet (S20).

According to this, checking the operation screen makes it possible to check what operation performed by a user with a GUI displayed on the operating device may generate an anomalous packet. Therefore, the information processing method according to an aspect of the present disclosure makes it possible to easily find the cause of generation of the anomalous packet. Further, making it possible to easily find the cause of generation of the anomalous packet makes it possible to reduce the amount of processing in an analysis or other examinations of the anomaly. Further, the analysis or other examinations of the anomaly can be rapidly conducted.

Technology 2 is directed to the information processing method according to technology 1, further including: acquiring operation information pertaining to a user's operation on an operating device; acquiring a packet; and establishing a link between the packet thus acquired and the operation information, wherein outputting the operation screen includes outputting the operation screen on the basis of the packet and the operation information thus linked.

The operation information is, for example, information contained in the aforementioned screen operation information table.

According to this, using information on the packet and the operation information thus linked makes it possible, for example, to, when an anomalous packet has been detected, easily grasp what user's operation generates a packet that is similar to the packet thus detected.

In a case where it is known in advance what operation is performed by the user in such a case where a packet is generated, the packet and operation information indicating the operation may be stored in advance in a storage device of an information processing apparatus that executes the information processing method. In such a case, the packet and the operation information indicating the operation may be acquired from the storage device. Further, for example, information in which the packet and the operation information indicating the operation are linked to each other may be stored in advance in the storage device of the information processing apparatus that executes the information processing method.

Further, a packet that is acquired may be a packet flowing through the network, or in a case where it is known in advance what packet flows through the network, the packet may be stored in advance in the storage device of the information processing apparatus that executes the information processing method. For example, a packet stored in the storage device may be acquired.

Technology 3 is directed to the information processing method according to technology 2, wherein acquiring the operation information includes acquiring the operation information containing a screenshot of a screen displayed on a display device of the operating device when the user executed, as an operation on the operating device, at least either a click of a mouse of the operating device or input to a keyboard of the operating device.

This makes it possible to easily acquire the operation information.

Technology 4 is directed to the information processing method according to technology 2 or 3, wherein the linking includes linking the packet thus acquired and the operation information acquired within a particular period of time corresponding to a time of acquisition of the packet.

In a case where a packet is generated by the user's operation, it is highly likely that the packet is generated immediately after the user's operation. Therefore, linking the packet thus acquired and the operation information acquired within a particular period of time corresponding to a time of acquisition of the packet makes it possible to accurately link the user's operation and the packet generated by the user's operation.

Technology 5 is directed to the information processing method according to technology 3, further including estimating, on the basis of the operation information, a position on the operation screen where a controlling value for controlling a controlled apparatus is being displayed, the controlling value being contained in a packet that is sent to the controlled apparatus.

In a case where the controlled apparatus is caused by an anomalous packet to perform an anomalous action, it is highly likely that the controlling value for controlling the controlled apparatus is set to an anomalous value in the anomalous packet. According to this, for example, outputting such an operation screen as to indicate the estimated position can make it easy for the user to find whether such a controlling value is appropriate.

Technology 6 is directed to the information processing method according to technology 5, wherein estimating the position where the controlling value is being displayed includes estimating, with reference to at least any of output obtained by performing OCR (optical character recognition) on the screenshot, coordinates of a position clicked, and information on the input to the keyboard, the position where the controlling value is being displayed.

This makes it possible to accurately estimate the position where the controlling value is being displayed.

Technology 7 is directed to the information processing method according to technology 5 or 6, wherein outputting the operation screen includes outputting the operation screen highlighting the position where the controlling value is being displayed.

That is, the information processing method includes, for example, estimating the operation screen, estimating the position on the operation screen thus estimated where the controlling value is displayed, and outputting the operation screen thus estimated with the position thus estimated highlighted. This can make it easy for the user to find whether the controlling value is appropriate. Alternatively, an operation screen on which the controlling value on the operation screen is replaced with a controlling value contained in an anomalous packet may be outputted. In a case where a controlling value of a packet outputted from the operating device is falsified, this can make it easy for the user to find whether the controlling value is anomalous.

Technology 8 is directed to the information processing method according to any of technologies 2 to 7, further including, in a case where the operation information linked to a packet of an identical type to a packet in which an anomaly was detected is not acquired, outputting the operation screen on the basis of metadata contained in the packet in which the anomaly was detected.

For example, the operation screen is outputted on the basis of the operation information linked to a packet (e.g. the packet of the identical control type ID) containing metadata of an identical type to the metadata contained in the packet (i.e. the anomalous packet) in which the anomaly was detected. Such information in which a packet and an image are linked to each other may be stored in advance in the storage device of the information processing apparatus. This makes it possible, even without operation information linked to the anomalous packet, to easily estimate what user's operation causes the anomalous packet to be outputted.

Technology 9 is directed to the information processing method according to any of technologies 3 and 5 to 7, further including, in a case where the operation information linked to a packet of an identical type to a packet in which an anomaly was detected is acquired, outputting, as the operation screen, the screenshot contained in the operation information linked to the packet of the identical type.

This makes it possible to easily estimate what user's operation causes an anomalous packet to be outputted.

Technology 10 is directed to an information processing apparatus including: a detector that detects an anomaly in a packet; and an output that, in a case where the anomaly in the packet is detected, outputs, on the basis of the packet, an operation screen estimated to generate the packet.

The detector is, for example, the aforementioned anomaly detector 103. The output is, for example, the aforementioned visualizer 111.

This brings about effects that are similar to those of an information processing method according to an aspect of the present disclosure.

Technology 11 is directed to a non-transitory computer-readable recording medium storing a program for causing a computer to execute the information processing method according to technologies 1 to 9.

This brings about effects that are similar to those of an information processing method according to an aspect of the present disclosure.

### Supplemental Remarks

As noted above, the embodiment has been described as an illustration of the techniques disclosed here. However, the techniques according to the present disclosure are not limited to this but are also applicable to embodiments subjected as appropriate to changes, substitutions, additions, omissions, or other alterations.

The following enumerates examples of modifications of the present disclosure.

(1) Although, in the embodiment, the description is based on the premise that a control packet is generated immediately after a screen operation, there may be, in actuality, cases where a schedule is set by a screen operation and a control packet is generated in accordance with the schedule. Therefore, it is not necessary to configure the settings so that a control packet is generated immediately after a screen operation. In such a case, a link between the screen operation and the control packet can be established by recognizing a screen for setting a schedule and recognizing the time of setting of the schedule.

(2) Although, in the embodiment, the description states that in step S1806, a screenshot acquired at a time closest to the current time is used, it is not necessary to use a screenshot acquired at a time closest to the current time. For example, a screenshot to be linked may be randomly selected from among one or more screenshots utilized to estimate the display position of a controlling value.

(3) In the embodiment, the description states that in step S1808, a place of interest is highlighted. Possible examples of methods for highlighting the place of interest include changing the color of the place of interest, surrounding the place of interest with a frame, and displaying an image with a mouse pointer displayed.

(4) In the embodiment, the display position is estimated by acquiring the output (text information) of OCR executed on a screenshot representing an operation screen being displayed on the display device, determining the degree of coincidence between the text information and the controlling value, and then estimating the coordinates of the display position. However, the estimation (determination) of the coordinates of the display position does not necessarily need to be based on the coincidence of character recognition results. Possible examples of methods for determining whether a screen operation corresponds to the controlling value include making a determination by acquiring the immediately preceding key input (keyboard input). Further, possible examples of methods for estimating the display position include determining the display position on the basis of a position clicked just before. Methods for determining a screen operation corresponding to the controlling value and methods for estimating the display position are not limited to those noted above and may be arbitrarily combined with each other.

(5) Although, in the embodiment, a process of estimating a position where a value, such as the controlling value, contained in a control packet is executed, a link between a screen layout of the control PC 200 and a control type ID corresponding to the user's operation may be acquired in advance from a configuration file or other files. In this case, the display position and display format (such as a text box or a button) of a user interface associated with operation of an object to be controlled can be read to the configuration file. This makes it possible to exactly re-create the state of display, thus making the display position estimation process per se unnecessary.

(6) The screen operation output apparatus 100 may be implemented as one apparatus including all of the constituent elements or may be implemented by allocating functions to a plurality of apparatuses that work together.

(7) A process that is executed by a particular processor may be executed by another processor. Further, the order of a plurality of processes may be changed, or the plurality of processes may be executed in parallel.

(8) Each apparatus may use any communication standard and is not limited to particular communication standards.

(9) Each constituent element may be implemented by executing a software program suited to that constituent element. Each constituent element may be implemented by a program executer such as a CPU or a processor reading out and executing a software program stored in a recording medium such as a hard disk or a semiconductor memory.

(10) Each constituent element may be implemented as hardware. For example, each constituent element may be a circuit (or an integrated circuit). These circuits may constitute one circuit as a whole or may each be separate circuits. Further, these circuits may each be a general-purpose circuit or may each be a dedicated circuit.

(11) It should be noted that general or specific embodiments may be implemented as an apparatus, a system, a method, an integrated circuit, a computer program, or a non-transitory computer-readable recording medium such as a CD-ROM. Alternatively, general or specific embodiments may be implemented as any selective combination of an apparatus, a system, a method, an integrated circuit, a computer program, and a storage medium.

(12) Communication between apparatuses in the foregoing embodiment is not limited to particular methods. Further, communication between apparatuses may be mediated by an intermediary device (such as a broadband router; not illustrated).

The present disclosure also encompasses other embodiments obtained by subjecting each embodiment to various modifications conceived of by persons skilled in the art or other embodiments achieved by arbitrarily combining constituent elements and functions of each embodiment without departing from the scope of the present disclosure.

The present disclosure is applicable to an apparatus for detecting an anomaly in a packet.

What is claimed is:

1. An information processing method comprising:
detecting an anomaly in a packet; and
in a case where the anomaly in the packet is detected, outputting, on the basis of the packet, an operation screen estimated to generate the packet.

2. The information processing method according to claim 1, further comprising:
acquiring operation information pertaining to a user's operation on an operating device;
acquiring a packet; and
establishing a link between the packet thus acquired and the operation information,
wherein outputting the operation screen includes outputting the operation screen on the basis of the packet and the operation information thus linked.

3. The information processing method according to claim 2, wherein acquiring the operation information includes acquiring the operation information containing a screenshot of a screen displayed on a display device of the operating device when the user executed, as an operation on the operating device, at least either a click of a mouse of the operating device or input to a keyboard of the operating device.

4. The information processing method according to claim 3, further comprising estimating, on the basis of the operation information, a position on the operation screen where a controlling value for controlling a controlled apparatus is being displayed, the controlling value being contained in a packet that is sent to the controlled apparatus.

5. The information processing method according to claim 4, wherein estimating the position where the controlling value is being displayed includes estimating, with reference to at least any of output obtained by performing OCR (optical character recognition) on the screenshot, coordinates of a position clicked, and information on the input to the keyboard, the position where the controlling value is being displayed.

6. The information processing method according to claim 4, wherein outputting the operation screen includes outputting the operation screen highlighting the position where the controlling value is being displayed.

7. The information processing method according to claim 3, further comprising, in a case where the operation information linked to a packet of an identical type to the packet in which an anomaly was detected is acquired, outputting, as the operation screen, the screenshot contained in the operation information linked to the packet of the identical type.

8. The information processing method according to claim 2, wherein the linking includes linking the packet thus acquired and the operation information acquired within a particular period of time corresponding to a time of acquisition of the packet.

9. The information processing method according to claim 2, further comprising, in a case where the operation information linked to a packet of an identical type to the packet in which an anomaly was detected is not acquired, outputting the operation screen on the basis of metadata contained in the packet in which the anomaly was detected.

10. An information processing apparatus comprising:
a detector that detects an anomaly in a packet; and
an output that, in a case where the anomaly in the packet is detected, outputs, on the basis of the packet, an operation screen estimated to generate the packet.

11. A non-transitory computer-readable recording medium storing a program for causing a computer to execute the information processing method according to claim 1.
